(19) United States
(12) Patent Application Publication
(10) Pub. No.: US 2006/0015552 A1
(43) Pub. Date: Jan. 19, 2006

(54) Analog square root calculating circuit for a sampled data system and method

(75) Inventor: Timothy James Streit, Mesa, AZ (US)

Correspondence Address: WELLS ST. JOHN P.S., 601 W. FIRST AVENUE, SUITE 1300, SPOKANE, WA, 99201, US

(73) Assignee: Anadigm, Inc.

(21) Appl. No.: 11/179,709

(22) Filed: Jul. 12, 2005

Related U.S. Application Data
(60) Provisional application No. 60/588,914, filed on Jul. 15, 2004.

(51) Int. Cl. G06F 7/38

(52) U.S. Cl. 708/490

(57) ABSTRACT

A square root calculating circuit is provided for an analog sampled data system. The square root calculating circuit includes a summing integrator circuit and a multiplier circuit. The summing integrator circuit has two inputs wherein the first input is configured to receive an input signal, Vᵢₙₚᵤₜ. The multiplier circuit is provided in a feedback loop to the summing integrator circuit. The multiplier circuit provides a second input to the summing integrator circuit. The multiplier is configured to produce a signal that is proportional to a product of two signals. Both signals represent an output of the summing integrator circuit, Vₒᵤₜₚᵤₜ, being proportional to the square root of the input signal, Vᵢₙₚᵤₜ. A method is also provided.

### RELATED PATENT DATA

This patent claims the benefit of U.S. Provisional Patent Application Ser. No. 60/588,914, entitled “Analog Square Root Calculating Circuit for a Sampled Data System and Method”, which was filed Jul. 15, 2004, and which is incorporated herein by reference.

### TECHNICAL FIELD

This invention pertains to circuitry for sampled data systems. More particularly, the present invention relates to analog square root calculating circuits and methods, as well as root mean square (RMS) circuits and digital signal processing (DSP) algorithms and methods.

### BACKGROUND OF THE INVENTION

There exist previously known techniques for realizing a square root of an input voltage with an analog square root calculating circuit that implements non-linear feedback loops. For example, FIG. 1 illustrates one prior art technique for realizing a square root function with a square root calculating circuit 10 that includes an operational amplifier (Op-Amp) 12 and a multiplier, or multiplying feedback element, 14. However, this technique only works for continuous time analog circuits when the input is limited to positive voltages. A negative input voltage will drive the output of this circuit to its negative limit. Furthermore, when this technique is implemented in a sampled data system such as a switched-capacitor circuit, additional problems arise. For example, a sampling induced delay in the multiplier feedback element 14 can cause this circuit to oscillate. Accordingly, improvements are needed in order to overcome these problems.

### SUMMARY OF THE INVENTION

Circuits and methods are implemented in an analog sampled data system in a manner that will produce a square root of an input voltage. The circuits can also be combined with a multiplier and a low pass filter (or a filtering multiplier) in order to produce a Root Mean Square (RMS) circuit. Furthermore, the circuits can be represented by difference equations, and methods can be applied in order to produce a digital signal processing (DSP) algorithm in order to calculate a square root value.

According to one aspect, a square root calculating circuit is provided for an analog sampled data system. The square root calculating circuit includes a summing integrator circuit and a multiplier circuit. The summing integrator circuit has two inputs wherein the first input is configured to receive an input signal, Vinput. The multiplier circuit is provided in a feedback loop to the summing integrator circuit. The multiplier circuit provides a second input to the summing integrator circuit. The multiplier is configured to produce a signal that is proportional to a product of two signals. Both signals represent an output of the summing integrator circuit, Voutput, being proportional to the square root of the input signal, Vᵢₙₚᵤₜ.

According to another aspect, a square root calculating circuit is provided for an analog sampled data system. The square root calculating circuit includes a low-pass filter and a divider circuit. The low-pass filter is configured to receive an input signal, V_{d input}, and produce an output signal, Vₒᵤₜₚᵤₜ. The divider circuit is provided as an input to the low-pass filter. The divider circuit is configured to receive an input signal, Vᵢₙₚᵤₜ, and produce an output signal, V_{d output}, equal to the input signal divided by a term proportional to the output signal, Vₒᵤₜₚᵤₜ.

According to yet another aspect, a square root calculating circuit is provided for an analog sampled data system. The square root calculating circuit includes a summing integrator and a multiplying feedback branch. The summing integrator has two inputs, wherein the first input is configured to receive an input signal, Vᵢₙₚᵤₜ. The multiplying feedback branch provides a second input to the summing integrator circuit. The multiplying feedback branch is configured to generate a product term of two input signals. Both input signals represent an output, Vₒᵤₜₚᵤₜ, of the summing integrator as being a square root of the input signal, Vᵢₙₚᵤₜ.

According to yet even another aspect, a configurable analog module is provided for configuring a field programmable analog array in order to implement a square root calculation for an analog sampled data system. The configurable analog module includes an analog switched-capacitor circuit. The analog switched-capacitor circuit is configured to calculate a square root of an input voltage from an analog sampled data system.

### BRIEF DESCRIPTION OF THE DRAWINGS

Preferred embodiments of the invention are described below with reference to the following accompanying drawings.

FIG. 1 is an electrical schematic diagram illustrating an analog square root circuit that is known in the art.

FIG. 2 is an electrical schematic diagram illustrating an analog square root circuit using switched-capacitors according to one aspect of the present invention.

FIG. 3 is an electrical schematic diagram illustrating another analog square root circuit using switched-capacitors according to another aspect of the present invention.

FIG. 4 is an electrical schematic diagram illustrating yet another analog square root circuit using switched-capacitors according to yet another aspect of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to several preferred embodiments of Applicant's invention. A square root calculating circuit and method are provided for use with an analog sampled data system. According to two aspects, square root calculation is provided for a sampled data system. According to another aspect, a non-linear input branch of an integrator is provided with a multiplying feedback branch in order to provide more compact, elegant circuitry for calculating a square root. Furthermore, the circuitry and methods can be applied to other sampled data systems.

For example, the circuits can be represented by difference equations, and the apparatus and method can be applied in order to produce a digital signal processing (DSP) algorithm in order to calculate a square root. Even furthermore, the circuitry can be used in conjunction with a multiplier and low-pass filter, or in conjunction with a filtering multiplier in order to produce a root mean square (RMS) circuit.

While the invention is described by way of several preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

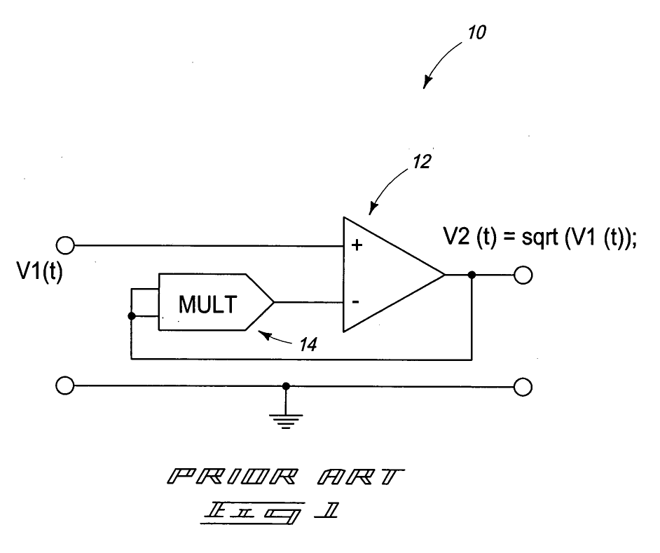

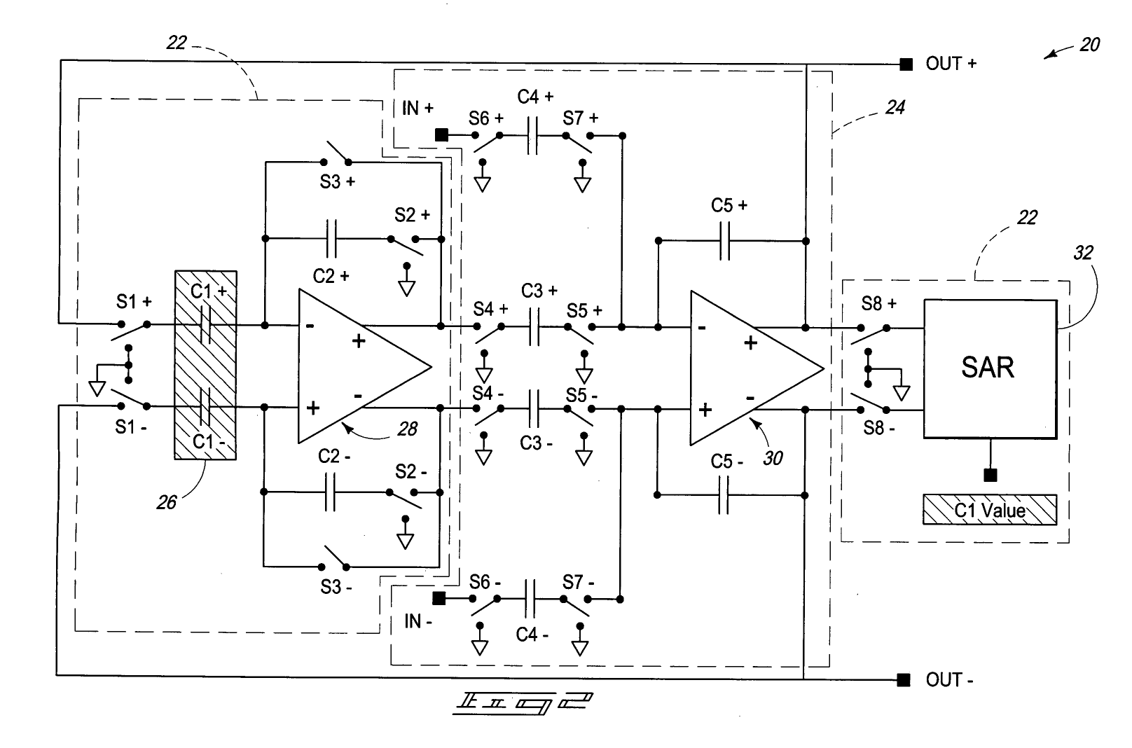

FIG. 2 a schematic diagram illustrating an analog square root calculating circuit 20 for use with an analog sampled data system according to one embodiment of the present invention. The present inventor discovered that analog square root calculating circuit 20 can be implemented as a switched capacitor circuit so that circuit 20 is capable of responding to a negative input voltage. More particularly, a standard multiplier (as shown in FIG. 1) is replaced by an element that produces an output voltage equal to input voltage multiplied by an absolute value of the input voltage. A feedback circuit results which can produce an output voltage equal to the sign of the input voltage multiplied by the square root of the absolute value of the input voltage:
Vₒᵤₜₚᵤₜ=sgn(Vᵢₙₚᵤₜ)\sqrt{abs}(Vᵢₙₚᵤₜ). [Equation 1]

In contrast, the prior art circuit 10 of FIG. 1 was found to encounter an oscillation problem due to delay when implemented in a sampled data system. The delay can be overcome by adding a low-pass filter to the output of the difference amplifier. Reduction of high frequency gain in the feedback loop results in a stable feedback system.

However, an additional improvement can be realized by replacing the difference amplifier and low-pass filter with a difference integrator. As well as providing a beneficial reduction in circuit elements, the difference integrator provides a high DC gain that is required in order to realize an accurate feedback loop, as well as to realize a reduction in high frequency gain that is required in order to achieve stability. The negative feedback that is applied to the difference integrator forms a low-pass filter in conjunction with a square root function.

The circuit 20 of FIG. 2 overcomes the problems associated with the prior art circuit 10 of FIG. 1 by replacing a standard multiplier with an element that produces Vₒᵤₜₚᵤₜ, as described above with reference to Equation 1.

As shown in FIG. 2, circuit 20 includes a multiplier circuit 22 and a summing integrator circuit 24. Multiplier circuit 22 includes digitally controlled capacitive circuit elements 26 that have values C1+and C1−, wherein the capacitive value of C1 is under the control of an analog-to-digital converter (ADC) 32. Accordingly, the capacitive circuit elements 26 provide a variable capacitance for the two inputs to an operational amplifier 28. As shown in FIG. 2, multiplier circuit 22 includes ADC 32, switches S8+, S8−, capacitive circuit elements 26 (C1+ and C1−), operational amplifier 28, and switches S1+, S1−, S2+, S2−, S3+, S3−, and capacitors C2+, C2−.

Switches S1+ and S1− cooperate with respective capacitive circuit elements 26 (C1+ and C1−) to each provide a switched capacitor implementation. Furthermore, capacitors C2+ and C2− cooperate with respective switches S2+ and S2− to each further provide a switched capacitor implementation.

Summing integrator circuit 24 includes another operational amplifier 30. Operational amplifier 30 comprises a fully differential amplifier, according to one implementation, having a pair of differential inputs and a pair of differential outputs. Also according to one construction, operational amplifier 28 similarly comprises a differential amplifier having a pair of differential inputs and a pair of differential outputs.

Operational amplifier 30 is configured to receive a pair of differential inputs via an array of switched capacitors. More particularly, switched capacitors are provided via switches S6+, S7+, and capacitor C4+; switches S6−, S7−, and capacitor C4−; switches S4+, S5+, and capacitor C3+; and switches S4−, S5−, and C3−. Summing integrator circuit 24 also includes capacitors C5+ and C5−, each provided in a feedback loop between respective differential outputs and inputs of operational amplifier 30.

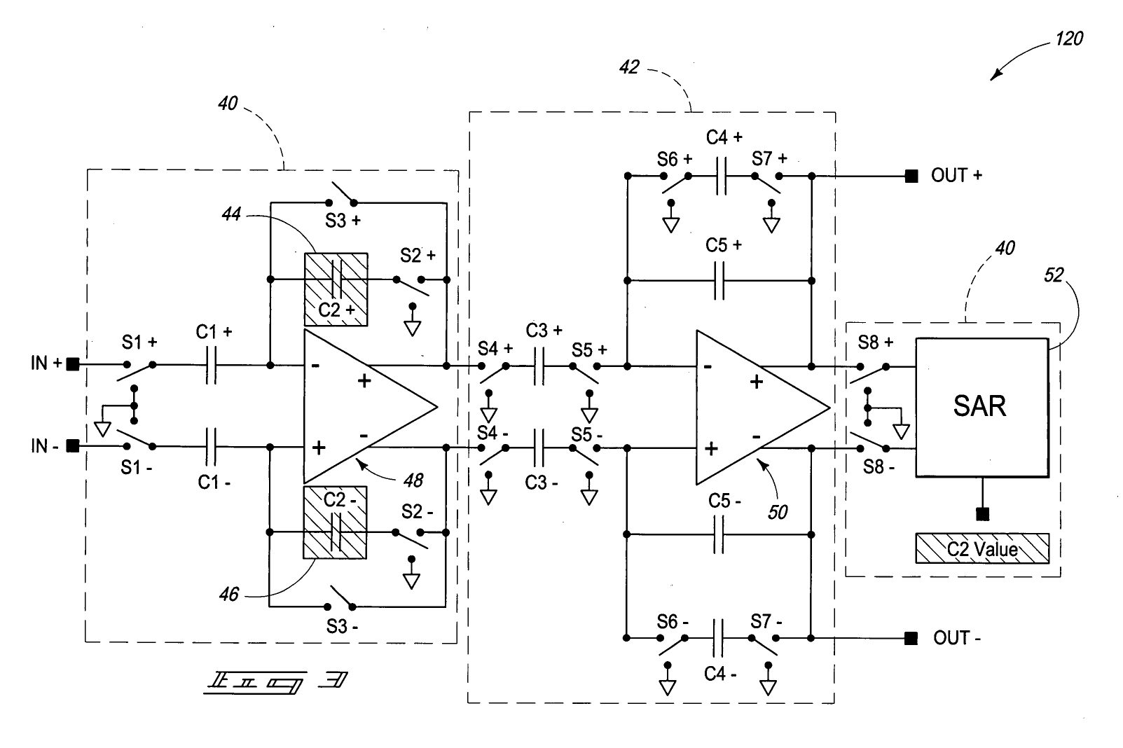

FIG. 3 is a schematic diagram illustrating an analog square root calculating circuit 120 that is realized as a switched-capacitor circuit according to another embodiment of the present invention. Analog square root calculating circuit 120 realizes a square root calculating circuit by combining a divider and a low-pass filter. More particularly, circuitry 120 comprises a divider circuit 40 and a low-pass filter 42.

In order to understand such implementation, it is beneficial to understand that a square root function can be realized with a divider element and a feedback circuit. For the case of continuous time analog circuits, a divider can be realized using a multiplier element that is provided in a feedback loop. By combining these concepts, a pair of feedback paths are provided to multiplier inputs, yielding the prior art circuit depicted in FIG. 1. However, a divider function can also be realized directly in a switched-capacitor circuit, thereby allowing a different implementation for an analog square root circuit. The resulting circuit will have the same problems of oscillation and inability to handle a negative input as was encountered with the multiplier based circuit of FIG. 1. However, the solutions that were implemented with respect to the circuit 20 of FIG. 2 can also be applied herein.

More particularly, low-pass filter 42 can be placed after the divider circuit 40 in order to reduce high frequency loop gain, thereby resulting in a stable circuit. A change that is imparted in the divider element of divider circuit 40 to produce an output voltage equal to input voltage divided by the absolute value of the feedback input voltage will again result in a feedback circuit that will produce an output voltage equal to the sign of the input voltage multiplied by the square root of the absolute value of the input voltage:
Vₒᵤₜₚᵤₜ=sgn(Vᵢₙₚᵤₜ)\sqrt{abs}(Vᵢₙₚᵤₜ). [Equation 1]

Accordingly, the output can be realized in a switched-capacitor circuit as illustrated in FIG. 3.

As shown in FIG. 3, divider circuit 40 includes operational amplifier 48, as well as a pair of differential capacitor elements 44 and 46. Differential capacitor elements 44 and 46 each comprise a digitally controlled capacitor for differential circuitry which is driven by an analog-to-digital converter (ADC) 52. More particularly, a value for C2 comprises a digital value (or word) that controls absolute value of capacitor C2.

As shown in FIG. 3, operational amplifier 48, according to one construction, comprises a fully differential amplifier with a pair of differential inputs and a pair of differential outputs. A switched capacitor array S1+, C1+, and S1−, C1−, respectively, is provided at each differential input to operational amplifier 48. Furthermore, a switched capacitor array S2+, C2+, and S2−, C2−, respectively, is provided on each feedback loop between a respective one of the differential outputs and differential inputs for operational amplifier 48. Divider circuit 40 also includes switches S3+ and S3−, as well as switches S8+ and S8−.

Low-pass filter 42 includes an operational amplifier 50. According to one construction, operational amplifier 50 comprises a fully differential amplifier with a pair of differential inputs and a pair of differential outputs. Switched capacitor arrays S4+, C3+, S5+, and S4−, C3−, S5− are provided at respective differential inputs for operational amplifier 50. Furthermore, switched capacitor arrays S6+, C4+, S7+, and S6−, C4−, S7− provide feedback between the respective differential output and differential input for operational amplifier 50. Low-pass filter 42 also includes capacitors C5+ and C5−.

It is understood that circuit 20 of FIG. 2 and circuit 120 of FIG. 3 can each be used in conjunction with a multiplier and a low-pass filter, or in conjunction with a filtering multiplier in order to produce a root mean square (RMS) circuit. Although the present solutions have been described for switched-capacitor circuits, the ideas presented herein are also applicable to other sampled data systems. For example, since these circuits can be represented by difference equations, these apparatus and methods could also be applied in order to produce a digital signal processing (DSP) algorithm in order to find a square root.

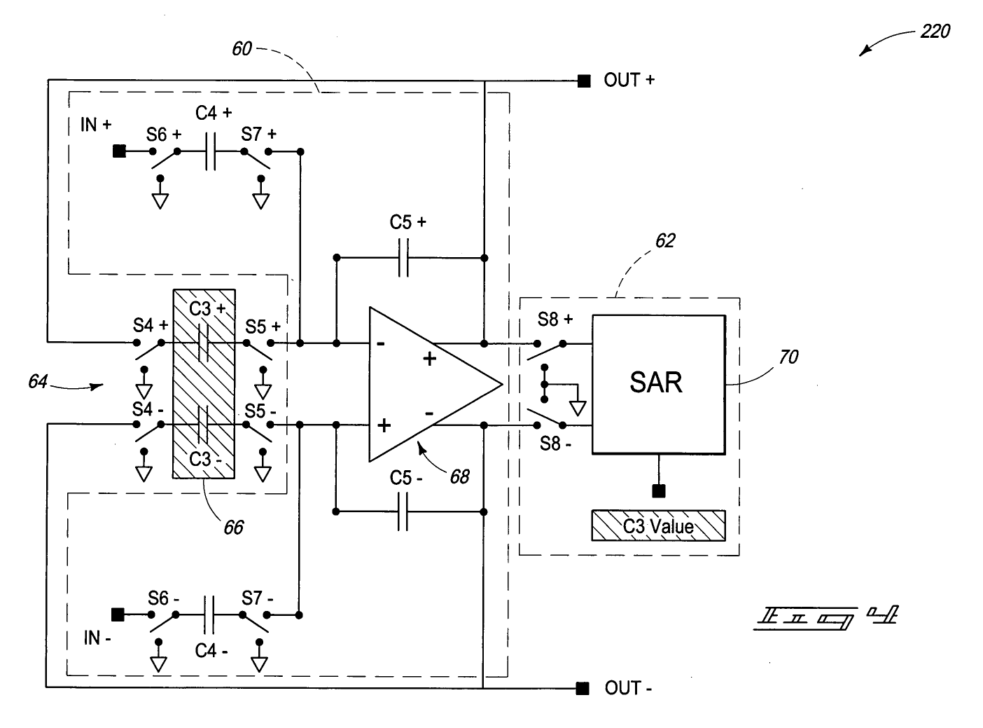

FIG. 4 is a schematic diagram illustrating an analog square root calculating circuit 220 for a sampled data system according to yet another embodiment of the present invention.

As shown in FIG. 4, analog square root calculating circuit 220 includes a summing integrator circuit 60, capacitor control circuitry 62, and a multiplying feedback branch. In essence, an improvement is realized in the present embodiment by combining a multiplying feedback element and a feedback input branch to a difference integrator into a single multiplying input (or feedback) branch 64. The resulting embodiment is implemented as a switched-capacitor circuit, as shown in FIG. 4.

In contrast with the circuitry 20 (of FIG. 2) and circuitry 120 (of FIG. 3), circuitry 220 utilizes fewer circuit components, which provides an improvement over the implementation previously depicted with reference to FIG. 2. Accordingly, performance is also improved with the single opamp implementation of circuitry 220 because the non-ideal input referred offset of the second opamp; namely, opamp 28 (of FIG. 2) and opamp 48 (of FIG. 3) is eliminated. Furthermore, the implementation does not have noise that is otherwise generated by opamps 28 (of FIG. 2) and 48 (of FIG. 3).

As shown in FIG. 4, multiplying feedback branch 64 comprises a non-linear circuit branch that effectively produces a filter having a corner frequency that is proportional to an input voltage for the circuit branch. In the present case, the corner frequency is therefore proportional to an output voltage of the square root circuit.

The concept of combining a non-linear element along with an input branch of an integrator can also be used in order to create a filtering divider circuit. It is interesting to note that, when a square root circuit is made from a divider and a low-pass filter, the resulting circuit is different from that depicted in FIG. 2. However, the same idea can be applied in order to remove the division sub-circuit and then replace it with a non-linear branch in the low-pass filter. This concept yields exactly the same switched-capacitor circuit implementation depicted in FIG. 4.

Circuit 220 of FIG. 4 can be used in conjunction with a multiplier and a low-pass filter in order to produce a root mean square (RMS) circuit. Alternatively, a circuit 220 of FIG. 2 can be used in conjunction with a filtering multiplier in order to produce a root mean square (RMS) circuit. Even furthermore, although this solution has been described for switched-capacitor circuits, the present ideas for the circuit 220 of FIG. 4 are also applicable to other sampled data systems. For example, circuit 220 can be represented by difference equations, and the present apparatus and method can be applied in order to produce a digital signal processing (DSP) algorithm in order to calculate a square root value.

ADC 32 (of FIG. 2), ADC 52 (of FIG. 3), and ADC 70 (of FIG. 4) each comprise analog-to-digital converters. According to one construction, such ADCs each comprise a successive approximation register (SAR) that uses a serial technique for finding successive bits and converting a signal from an analog signal to a digital signal. However, it is understood that other circuitry, such as analog to digital converters, can be utilized in order to set the respective value for a capacitor (C1).

The embodiments depicted in FIGS. 2-4 illustrate circuitry and methods that deploy a multiplier (or multiplier circuit) within a very tight feedback loop based upon the utilization of switched capacitors. A multiplier that is linear over a wide range is utilized in combination with a digital version of a signal in order to vary the value of a capacitor. The digital version of the signal is then used to control the set capacitor in a manner that affects the multiplier. A similar explanation is provided when implementing the divider circuit 40 of FIG. 3.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A square root calculating circuit for an analog sampled data system, comprising:
a summing integrator circuit with two inputs wherein the first input is configured to receive an input signal, Vᵢₙₚᵤₜ; and
a multiplier circuit provided in a feedback loop to the summing integrator and providing a second input to the summing integrator circuit, the multiplier configured to produce a signal proportional to a product of two signals, both representing an output of the summing integrator circuit, Vₒᵤₜₚᵤₜ, being proportional to the square root of the input signal, Vᵢₙₚᵤₜ.

2. The analog square root calculating circuit of claim 1 further comprising a feedback circuit wherein the multiplier is configured to produce a signal proportional to a product of a signal and an absolute value of the signal, both representing the output of the summing integrator circuit, Vₒᵤₜₚᵤₜ, being proportional to
$$sgn ( {V}_{input} ) \sqrt{abs ( {V}_{input} )} .$$

3. The analog square root calculating circuit of claim 1 wherein the summing integrator circuit comprises an operational amplifier with a feedback loop extending between an input of the operational amplifier and an output of the operational amplifier.

4. The analog square root calculating circuit of claim 1 wherein the multiplier circuit comprises an operational amplifier.

5. The analog square root calculating circuit of claim 4 wherein the operational amplifier comprises a fully-differential amplifier.

6. The analog square root calculating circuit of claim 4 wherein the multiplier circuit comprises at least one digitally controlled capacitive circuit element provided between the output, Vₒᵤₜₚᵤₜ, and an input to the operational amplifier.

7. The analog square root calculating circuit of claim 6 wherein the multiplier circuit comprises an analog-to-digital converter configured to generate a digital capacitance value to control capacitance of the at least one digitally controlled capacitive circuit.

8. The analog square root calculating circuit of claim 1 wherein the summing integrator circuit comprises an operational amplifier, and further comprising a plurality of capacitors connected to the operational amplifier, at least one of the capacitors being switchable.

9. The analog square root calculating circuit of claim 1 wherein the summing integrator circuit is implemented with a single operational amplifier and the multiplier circuit is implemented with a single operational amplifier.

10. A square root calculating circuit for an analog sampled data system, comprising:
a low-pass filter configured to receive an input signal, V_{d}, and produce an output signal, Vₒᵤₜₚᵤₜ; and
a divider circuit provided as an input to the low-pass filter, configured to receive an input signal, Vᵢₙₚᵤₜ, and produce an output signal, V_{d}, equal to the input signal divided by a term proportional to the output signal, Vₒᵤₜₚᵤₜ.

11. The analog square root calculating circuit of claim 10 wherein the low-pass filter comprises an operational amplifier having at least one input and at least one output.

12. The analog square root calculating circuit of claim 11 wherein the low-pass filter further comprises a plurality of capacitors and a plurality of controllable switches connected to the operational amplifier to provide switchable capacitors.

13. The analog square root calculating circuit of claim 10 wherein the divider circuit comprises an analog-to-digital converter.

14. The analog square root calculating circuit of claim 10 wherein Vₒᵤₜₚᵤₜ is proportional to
$$sgn ( {V}_{input} ) \sqrt{abs ( {V}_{input} )} .$$

15. The analog square root calculating circuit of claim 10 wherein the divider circuit comprises an operational amplifier having at least one input and at least one output.

16. The analog square root calculating circuit of claim 15 wherein the divider circuit further comprises at least one controllable switch and at least one respective capacitor connected to the operational amplifier.

17. The analog square root calculating circuit of claim 15 further comprising a controllable capacitive circuitry element and a controllable switch in series with the element provided between the input and the output of the operational amplifier.

18. The analog square root calculating circuit of claim 17 wherein the operational amplifier is a fully differential amplifier having a pair of inputs and a pair of outputs, and a pair of controllable capacitive circuitry elements and controllable switches are provided in series, respectively, across one of the inputs and the outputs and another of the inputs and the outputs.

19. The analog square root calculating circuit of claim 15 wherein the output voltage is proportional to the input voltage divided by an absolute value of the feedback input voltage.

20. A square root calculating circuit for an analog sampled data system, comprising:
a summing integrator with two inputs wherein the first input is configured to receive an input signal, Vᵢₙₚᵤₜ; and
a multiplying feedback branch providing a second input to the summing integrator circuit, configured to generate a product term of two input signals, both input signals representing an output, Vₒᵤₜₚᵤₜ, of the summing integrator as being a square root of the input signal, Vᵢₙₚᵤₜ.

21. The switched-capacitor circuit of claim 20 further comprising an analog-to-digital converter and a multiplying feedback branch with switched capacitors, wherein the switched capacitors comprise digitally controlled capacitive circuitry, and wherein the digitally controlled capacitive circuitry is configured to receive a digital input signal from the analog-to-digital converter analogous to an output, Vₒᵤₜₚᵤₜ, from the summing integrator.

22. The switched-capacitor circuit of claim 20 wherein the digitally controlled capacitive circuitry comprises a differential pair of capacitor elements of a switched capacitor circuit, wherein the capacitive value of each capacitor element is placed under control of the analog-to-digital converter so as to provide a differential, variable capacitance as the differential input signal to the multiplying feedback branch.

23. The switched-capacitor circuit of claim 20 wherein the summing integrator has a single operational amplifier.

24. The switched-capacitor circuit of claim 23 wherein the operational amplifier comprises a fully differential amplifier with differential inputs and differential outputs.

25. The switched-capacitor circuit of claim 24 wherein the multiplying feedback branch is configured to provide a differential output signal to the differential inputs of the differential amplifier responsive to receiving a differential input signal from the differential outputs of the summing integrator.

26. A configurable analog module for configuring a field programmable analog array to implement a square root calculation for an analog sampled data system, comprising:
an analog switched-capacitor circuit configured to calculate a square root of an input voltage from an analog sampled data system.

27. The configurable analog module of claim 26 wherein the analog switched-capacitor circuit comprises at least one operational amplifier.

28. The configurable analog module of claim 27 wherein the analog switched-capacitor circuit has a single operational amplifier.

29. The configurable analog module of claim 27 wherein the operational amplifier comprises a fully differential amplifier with differential inputs and differential outputs.

30. The configurable analog module of claim 26 further comprising a summing integrator.

31. The configurable analog module of claim 30 further comprising a multiplying feedback branch with a single operational amplifier.
